(19) United States
(12) Patent Application Publication
(10) Pub. No.: US 2020/0190302 A1
(43) Pub. Date: Jun. 18, 2020

(54) POLYPROPYLENE COMPOSITIONS CONTAINING GLASS FIBER FILLERS

(71) Applicant: BASELL POLIOLEFINE ITALIA S.R.L., MILANO (IT)

(72) Inventors: CLAUDIO CAVALIERI, FERRARA (IT); MICHELE GRAZZI, FERRARA (IT); RAINER KOEHLER, PEGNITZ (DE); JURGEN ROHRMANN, KELKHEIM (DE)

(73) Assignee: BASELL POLIOLEFINE ITALIA S.R.L., MILANO (IT)

(21) Appl. No.: 16/348,970

(22) PCT Filed: Oct. 31, 2017
(86) PCT No.: PCT/EP2017/077854

§ 371 Date: May 10, 2019

(30) Foreign Application Priority Data
Nov. 11, 2016 (EP) 16198425.7

(51) Int. Cl. C08L 23/12; C08L 23/14; C08L 23/06; C08L 23/08; C08L 23/18; C08K 7/14; B29C 45/00; B29C 48/00

(52) U.S. Cl. CPC C08L 23/12; C08L 23/14; C08L 23/06; C08L 23/0815; C08L 2205/035; C08K 7/14; B29C 45/0001; B29C 48/022; C08L 2203/30; C08L 23/18

(57) ABSTRACT

A polypropylene composition containing glass fiber fillers, having a high Melt Flow Rate (MFR) and a good balance of mechanical properties. The compositions show excellent mechanical (high stiffness and ductility) and thermal properties (low shrinkage) while displaying a boost of the final MFR, notwithstanding the presence of glass fibers.

### FIELD OF THE INVENTION

In general, the present disclosure relates to the field of chemistry. More specifically, the present disclosure relates to polymer chemistry. In particular, the present disclosure relates to polypropylene compositions containing glass fiber fillers having a high Melt Flow Rate (MFR) and a good balance of mechanical properties.

### BACKGROUND OF THE INVENTION

In the automotive industry, 10-80% by weight of glass fiber reinforced thermoplastic polyolefin compound for injection molding is used for aesthetical automotive interior applications. These materials may be characterized by a soft touch haptic, a matte surface, enhanced sound dampening qualities with stiffness and scratch resistance. In some instances, trim components for interior designs of cars and airplanes as well as external car parts are prepared from these thermoplastics.

### DESCRIPTION OF THE INVENTION

The present disclosure provides a composition having a melt flow rate, measured according to ISO 1133 with a load of 2.16 kg at 230° C., of from 12 to 100 g/10 min, alternatively from 12 to 50 g/10 min, and made from or containing:
A) 30-60% by weight, alternatively 40-55% by weight, of a polyolefin composition selected between AX and AY,
wherein AX is made from or contains:
   (A1) 5-35% by weight of a propylene-based polymer containing 90% by weight or more of propylene units and 10% by weight or less of a fraction soluble in xylene at 25° C. (XSA1), where both the amount of propylene units and of the fraction XSA1 refer to the weight of (A1);
   (B1) 25-50% by weight of an ethylene homopolymer containing 5% by weight or less of a fraction soluble in xylene at 25° C. (XSB1) with respect to the weight of (B1); and
   (C1) 30-60% by weight of a copolymer of ethylene and propylene containing from 25% to 75% by weight of ethylene units and 55% to 95% by weight of a fraction soluble in xylene at 25° C. (XSC1), where both the amount of ethylene units and the fraction XSC1 refer to the weight of (C1);
   wherein the amounts of (A1), (B1) and (C1) refer to the total weight of (A1)+(B1)+(C1); and
AY is made from or contains:
   (A2) 5-35% by weight of a propylene-based polymer containing 90% by weight or more of propylene units and 10% by weight or less of a fraction soluble in xylene at 25° C. (XSA2), where both the amount of propylene units and of the fraction XSA2 refer to the weight of (A2);
   (B2) 25-50% by weight of a copolymer of ethylene and a C3-C8 alpha-olefin containing from 0.1% to 20% by weight of alpha-olefin units and 75% by weight or less of a fraction soluble in xylene at 25° C. (XSB2), where both the amount of ethylene units and of the fraction XSB2 refer to the weight of (B2); and
   (C2) 30-60% by weight of a copolymer of ethylene and propylene containing from 25% to 75% by weight of ethylene units and 55% to 95% by weight of a fraction soluble in xylene at 25° C. (XSC2), where both the amount of ethylene units and of the fraction XSC2 refer to the weight of (C2);
   wherein the amounts of (A2), (B2) and (C2) refer to the total weight of (A2)+(B2)+(C2);
B) 5-30% by weight, alternatively 10-25% by weight, of a glass fiber filler;
C) 0-5% by weight, alternatively 0.5-3% by weight, of a compatibilizer; and
D) 10-40% by weight, alternatively 15-35% by weight, of a polypropylene component selected from propylene homopolymers, propylene copolymers containing up to 5% by moles of ethylene or a C₄-C₁₀ α-olefin, and combinations thereof.

### Component A

In some embodiments, component A is produced using polymerization processes carried out in the presence of stereospecific Ziegler-Natta catalysts supported on magnesium dihalides.

In some embodiments, the polyolefin composition AX is prepared according to the process and conditions described in WIPO Appl. No. PCT/EP2016/064450.

In additional embodiments, the polyolefin composition AY is prepared according to the process and conditions described in WIPO Appl. No. PCT/EP2016/064453.

### Component B

The filler component B is made from or contains fibers made of glass. In some embodiments, the glass fibers are cut glass fibers or long glass fibers, or in the form of continuous filament fibers, including cut glass fibers In some instances, the glass are described as short fibers or chopped strands.

In some embodiments, the glass fibers have a length of from 1 to 50 mm.

In some embodiments, the cut or short glass fibers have a length of from 1 to 6 mm, alternatively from 3 to 4.5 mm, and a diameter of from 8 to 15 μm, alternatively from 10 to 13 μm.

Some examples of component B are the following commercial products: Glass Fibers ECS O3T 480, sold by Nippon Electric Glass Company Ltd., and Chopped Glass Fibers Chopvantage™ HP 3270, sold by PPG Industries Fiber Glass Americas.

### Component C

In some embodiments, the polypropylene compositions of the present disclosure are further made from or contain a compatibilizer C.

In some embodiments, the compatibilizers are made from or contain a modified (functionalized) polymer and, optionally, a low molecular weight compound having reactive polar groups. In some embodiments, modified olefin polymers are used. It is believed that the modified olefin polymers are compatible with the polymeric component of the compositions of the present disclosure. In some embodiments, the modified olefin polymers are selected from the group consisting of propylene homopolymers and copolymers including copolymers of ethylene and propylene with each other or with other alpha-olefins. In some embodiments, modified polyethylene is used.

In some embodiments and in terms of structure, the modified polymers are selected from graft or block copolymers.

In some embodiments, modified polymers containing groups derived from polar compounds, including but not limited to acid anhydrides, carboxylic acids, carboxylic acid derivatives, primary and secondary amines, hydroxyl compounds, oxazoline, epoxides and ionic compounds, are used.

In some embodiments, the polar compounds are selected from the group consisting of unsaturated cyclic anhydrides, their aliphatic diesters, and diacid derivatives. In some embodiments, maleic anhydride and compounds selected from C₁-C₁₀ linear and branched dialkyl maleates, C₁-C₁₀ linear and branched dialkyl fumarates, itaconic anhydride, C₁-C₁₀ linear and branched itaconic acid, dialkyl esters, maleic acid, fumaric acid, itaconic acid and mixtures thereof, are used.

In additional embodiments, a propylene polymer grafted with maleic anhydride as the modified polymer is used.

In some embodiments, the modified polymer(s) are produced by reactive extrusion of the polymer with maleic anhydride in the presence of free radical generators (like organic peroxides), as disclosed in European Patent Application No. EP0572028.

In some embodiments, the amounts of groups deriving from polar compounds in the modified polymers of the present disclosure are from 0.5 to 3% by weight.

In further embodiments, MFR values for the modified polymers are from 50 to 400 g/10 min.

In some embodiments, a masterbatch, which is made from or contains fillers and the compatibilizers in premixed form, is used for producing the modified polymers.

Some examples of component C are the following commercial products: Exxelor™ PO 1020, sold by ExxonMobil Chemical Company, SCONA™ TPPP 8112 FA, sold by Byk (Altana Group), SCONA™ TPPP 8112 GA sold by Byk (Altana Group), Bondyram™ 1101, sold by Polyram, and POLYBOND™ 3200, sold by Chemtura.

### Component D

In some embodiments, Component D is a high melt flow rate (MFR) component. It is believed that the MFR value of component D results from mixing various propylene homopolymers or copolymers with different MFR values.

In such mixtures the MFR value for component D is determined, on the basis of the amounts and MFR values of the single polymers, by correlation between the MFR of a polyolefin composition and the MFR of the separate components, which in the case of two polymer components D¹ and D², is expressed as follows:

ln MFR^{D}=[W_{D}¹/(W_{D}¹+W_{D}²)]×ln MFR¹+[W_{D}²/(W_{D}¹+W_{D}²)]×ln MFR²

where W_{D}¹ and W_{D}² represent the weight of components D¹ and D², respectively while MFR^{D} represents the calculated value of MFR for component D and MFR¹ and MFR² represent the MFR of components D¹ and D² respectively.

In some embodiments, when combinations (blends) of the propylene homopolymers or copolymers are used as polypropylene component D, blending at least two homopolymers or copolymers with different MFR values, where the difference is at least 3 g/10 min, alternatively at least 10 g/10 min, is performed.

In some embodiments, when the MFR of the polypropylene component D is less than 500 g/10 min, alternatively from 0.3 to 450 g/10 min, component D is made from or contains two polymer fractions, D^{I} and D^{II}, selected from the above referenced propylene homopolymers and copolymers, where fraction D^{II} has a higher MFR value with respect to D^{I}, with a difference in the MFR values as referenced above.

In additional embodiments, fraction D^{II} has a MFR value from 500 to 2,500 g/10 min, alternatively from 1,200 to 2,500 g/10 min.

In further embodiments, from 5 to 80% by weight of D^{I} and 20 to 95% by weight of D^{II}, alternatively from 10 to 70% by weight of D^{I} and 30 to 90% by weight of D^{II}, referring to the total weight of D, is used.

In some embodiments, the MFR values are obtained without any degradation treatment. As such, in some embodiments, the polypropylene component D is made of “as-polymerized” propylene polymers, not subjected to any additional treatment after polymerization that is able to change the MFR value. Thus and in these embodiments, the molecular weights of the polypropylene component D are directly obtained in the polymerization process used to prepare the propylene polymers.

Alternatively, the MFR values are obtained by the degradation (visbreaking) of propylene polymers having lower MFR values.

The MFR values for the polypropylene component D are measured according to ISO 1133, with a load of 2.16 kg at 230° C.

In some embodiments, the comonomers in the propylene copolymers present in the polypropylene component D) are selected from ethylene and C₄-C₁₀ α-olefins. In some embodiments, the C₄-C₁₀ α-olefins are selected from the group consisting of butene-1, pentene-1, 4-methylpentene-1, hexene-1 and octene-1.

In some embodiments, the propylene polymers and copolymers of the polypropylene component D are prepared by using a Ziegler-Natta catalyst or a metallocene-based catalyst system in the polymerization process.

In some embodiments, the catalysts and the polymerization processes are as described in Patent Cooperation Treaty Publication No. WO2010/069998, which is incorporated by reference and describes processes for preparing components D^{II} and D^{I}.

### Composition Comprising Components A, B, C and D

The compositions according to the present disclosure are obtainable by melting and mixing the components in a mixing apparatus at temperatures from 180 to 320° C., alternatively from 200 to 280° C., alternatively from 200 to 260° C.

In some embodiments, the mixing apparatuses include extruders and kneaders such as twin-screw extruders. In some embodiments, the components are pre-mixed at room temperature in a mixing apparatus.

In some embodiments, initially melting the polymeric components A and D and optionally component C, and subsequently mixing component B with the melt, reduces the abrasion in the mixing apparatus and the fiber breakage.

In some embodiments, the preparation of the polypropylene compositions of the present disclosure, in addition to the main components A and B and D and optionally compatibilizing agent(s) C, the propylene compositions is further made from or contains additives, such as stabilizing agents (for protection against heat, light, UV radiation), plasticizers, antistatics and water repellant agents. In some embodiments, the amount of such additives (in the form of an add pack) is less than 10 wt % with respect to the total weight of the composition.

In some embodiments, the compositions of the present disclosure are used in (i) injection-molded articles such as interior parts for automotive, electrical appliances, furniture, (ii) formed articles such as sheets, parts for electrical appliances, furniture, housewares, and (iii) masterbatches and concentrates. As used herein, the term “masterbatch” refers to a concentrated mixture of pigments or additives encapsulated during a high temperature process into a carrier resin, which is then cooled and reduced into a granular shape. In some embodiments, masterbatches and concentrates allow the processor to color raw polymer economically during a plastic manufacturing process.

The following analytical methods are used to determine the properties reported in the description and in the examples.

Melt Flow Rate (MFR):

ISO 1133 with a load of 2.16 kg at 230° C.;

Flexural Modulus (Secant):

ISO 178 on rectangular specimens 80×10×4 mm from T-bars ISO527-1 Type 1A;

Impact Notched:

ISO 179 (type 1, edgewise, Notch A) on rectangular specimens comprising components A, B, C and D 80×10×4 mm from T-bars ISO527-1 Type 1A;

Longitudinal and Transversal Thermal Shrinkage:

ISO 2554 for 48 hours at 40 bars and at room temperature.

Xylene Cold Soluble Content (XS):

Xylene soluble fraction is determined according to the following method:

2.5 g of polymer and 250 cm³ of o-xylene were introduced in a glass flask equipped with a refrigerator and a magnetic stirrer. The temperature was raised in 30 minutes from room temperature up to the boiling point of the solvent (135° C.). The resulting clear solution was then kept under reflux and stirred for an additional 30 minutes. The closed flask was then kept in a thermostatic water bath at 25° C. for 30 minutes, thereby permitting crystallization of the insoluble (XI) part of the sample. The resulting solid was then filtered on quick filtering paper. 100 cm³ of the filtered liquid was poured in a pre-weighed aluminum container, which was heated under nitrogen flow to remove the solvent by evaporation. The container was placed in an oven at 80° C. under vacuum to dry the sample until a constant weight was obtained. The percent by weight of polymer soluble and insoluble in xylene at 25° C. was determined.

Intrinsic Viscosity (IV):

The sample was dissolved in tetrahydronaphthalene at 135° C. and then poured into a capillary viscometer. The viscometer tube (Ubbelohde type) was surrounded by a cylindrical glass jacket; this setup allowed for temperature control with a circulating thermostated liquid. The downward passage of the meniscus was timed by a photoelectric device.

The passage of the meniscus in front of the upper lamp started the counter, which had a quartz crystal oscillator. The meniscus stopped the counter as the meniscus passed the lower lamp and the efflux time was registered: this value was converted into a value of intrinsic viscosity through Huggins' equation (Huggins, M. L., J. Am. Chem. Soc., 1942, 64, 2716), based upon the flow time of the pure solvent at the same experimental conditions (same viscometer and same temperature). A single polymer solution was used to determine [η].

Ethylene Comonomer Content (C₂-Content) for HDPE-Containing Polyolefin Composition:

The content of comonomer was determined by infrared (IR) spectroscopy by collecting an IR spectrum of the sample vs. an air background with a Fourier Transform Infrared (FTIR) spectrometer. The instrument data acquisition parameters were:
a) purge time: 30 seconds minimum
b) collect time: 3 minutes minimum
c) apodization: Happ-Genzel
d) resolution: 2 cm-1.

Sample Preparation—Using a hydraulic press, a thick sheet was obtained by compression molding about 1 g of sample between two aluminum foils. A small portion was cut from this sheet to mold a film. The film thickness was set to have a maximum absorbance of the CH₂ absorption band recorded at ˜720 cm⁻¹ of 1.3 a.u. (% Transmittance>5%). Molding conditions were 180±10° C. (356° F.) and the pressure was around 10 kg/cm² (142.2 PSI) for about one minute. The pressure was then released, the sample was removed from the press and then cooled to room temperature. The spectrum of pressed film sample was recorded in absorbance vs. wavenumbers (cm⁻¹). The following measurements were used to calculate ethylene (C₂) content:
A) Area (Aₜ) of the combination absorption bands between 4482 and 3950 cm⁻¹, which was used for spectrometric normalization of film thickness; and
B) Area (A_{C2}) of the absorption band due to methylenic sequences (CH₂ rocking vibration) in the range 660 to 790 cm⁻¹ after a proper digital subtraction of an isotactic polypropylene (IPP) reference spectrum.

The ratio A_{C2}/Aₜ was calibrated by analyzing reference ethylene-propylene copolymers by NMR spectroscopy. A calibration straight line was obtained by plotting A_{C2}/Aₜ versus ethylene weight percent (% C₂ wt) and the slope g was calculated from a linear regression. The spectra of the samples were recorded and then the corresponding (Aₜ) and (A_{C2}) were calculated. The ethylene content (% C₂ wt) of the samples were calculated as follows:

$$\% C 2 wt = \frac{\frac{{A}_{C 2}}{{A}_{t}}}{g}$$

Comonomer (C₂ and C₄) Content for LLDPE-Containing Polyolefin Composition

The content of comonomers was determined by infrared (IR) spectroscopy by collecting the IR spectrum of the sample vs. an air background with a Fourier Transform Infrared (FTIR) spectrometer. The instrument data acquisition parameters were:
a) purge time: 30 seconds minimum
b) collect time: 3 minutes minimum
c) apodization: Happ-Genzel
d) resolution: 2 cm⁻¹.

Sample Preparation—Using a hydraulic press, a thick sheet was obtained by compression molding about 1 g of sample between two aluminum foils. A small portion was cut from this sheet to mold a film. The film thickness was set to have a maximum absorbance of the CH₂ absorption band recorded at ˜720 cm⁻¹ of 1.3 a.u. (% Transmittance>5%). Molding conditions were 180±10° C. (356° F.) and the pressure was around 10 kg/cm² (142.2 PSI) for about one minute. The pressure was then released, the sample was removed from the press and cooled to room temperature. The spectrum of pressed film sample was recorded in absorbance vs. wavenumbers (cm⁻¹). The following measurements were used to calculate ethylene (C₂) and 1-butene (C₄) contents:
A) Area (Aₜ) of the combination absorption bands between 4482 and 3950 cm⁻¹ which was used for spectrometric normalization of film thickness; and
B) Area (A_{C2}) of the absorption band due to methylenic sequences (CH₂ rocking vibration) in the range 660 to 790 cm⁻¹ after a proper digital subtraction of an isotactic polypropylene (IPP) and a C₂C₄ references spectrum.

The factor of subtraction (FCR_{C4}) between the spectrum of the polymer sample and the C₂C₄ reference spectrum. The reference spectrum was obtained by digital subtraction of a linear polyethylene from a C₂C₄ copolymer to extract the C₄ band (ethyl group at ˜771 cm⁻¹).

The ratio A_{C2}/Aₜ was calibrated by analyzing reference ethylene-propylene copolymers by NMR spectroscopy. To calculate the ethylene (C₂) and 1-butene (C₄) content, calibration curves were obtained by using references samples of ethylene and 1-butene detected by ¹³C-NMR.

Calibration for ethylene—A calibration curve was obtained by plotting A_{C2}/Aₜ versus ethylene molar percent (% C2m), and the coefficient a_{C2}, b_{C2} and c_{C2}, then calculated from a “linear regression”.

Calibration for 1-butene—A calibration curve was obtained by plotting FCR_{C4}/Aₜ versus butane molar percent (% C₄m) and the coefficients act, b_{C4} and C_{C4}, then calculated from a “linear regression”.

The spectra of the samples were recorded and then (Aₜ), (A_{C2}) and (FCR_{C4}) of the samples were calculated.

The ethylene content (% molar fraction C2m) of the samples were calculated as follows:

$$\% C 2 m = - {b}_{C 2} + \frac{\sqrt{{b}_{C 2}^{2} - 4 \cdot {a}_{C 2} \cdot ( {c}_{C 2} - \frac{{A}_{C 2}}{{A}_{t}} )}}{2 \cdot {a}_{C 2}}$$

The 1-butene content (% molar fraction C4m) of the samples were calculated as follows:

$$\% C 4 m = - {b}_{C 4} + \frac{\sqrt{{b}_{C 4}^{2} - 4 \cdot {a}_{C 4} \cdot ( {c}_{C 4} - \frac{{FCR}_{C 4}}{{A}_{t}} )}}{2 \cdot {a}_{C 4}}$$

a_{C4}, b_{C4}, c_{C4} a_{C2}, b_{C2}, c_{C2} are the coefficients of the two calibrations.

Changes from mol % to wt % were calculated by using molecular weights.

### C₃-Content:

this value (% wt) was calculated after having determined the C₂ or C₂ and C₄ content, as the complement to 100.

Density: ISO 1183-1

The following examples are given for illustrating but not limiting purposes.

### EXAMPLES

### Examples 1, 2, 3, 4, 5 and 6 and Comparative Examples 1, 2 and 3

The following materials were used as components A, B and C and D.

### Component A

SOFTELL CA 7469 A: a commercial thermoplastic polyolefin (TPO) made by LyondellBasell's proprietary Catalloy technology. The thermoplastic polyolefin had an MFR of 0.50, a total C₂ (ethylene) content of 42.2% by weight, and a total xylene cold soluble content (XS) of 57% by weight, wherein the xylene cold soluble fraction had an intrinsic viscosity (IV) of 4.15 dl/g.

HIFLEX CA 7600 A: a commercial soft thermoplastic polyolefin (TPO), manufactured using the LyondellBasell proprietary Catalloy process technology. The thermoplastic polyolefin had an MFR of 2.15, a total C₂(ethylene)/C₄(1-butene) content of 51.9/3.8% by weight, and a total xylene cold soluble content (XS) of 44% by weight, wherein the xylene cold soluble fraction had an intrinsic viscosity (IV) of 2.40 dl/g.

Polyolefin AX1 (HD based) and Polyolefin AX2 (HD based) were prepared as described in the Examples section of WIPO Appl. No. PCT/EP2016/064450, but with the differences reported in the following table regarding the composition of the single components:

TABLE AX

| | | Polyolefin | Polyolefin |
|---|---|---|---|
| Component AX | | AX1 | AX2 |
| 1^{st} Reactor - component (A1) | | | |
| Temperature | ° C. | 60 | 60 |
| Pressure | barg | 16 | 16 |
| H₂/C₃₋ | mol. | 0.23 | 0.25 |
| Split | wt % | 17 | 19 |
| Xylene soluble of (A1) (XS_{A1}) | wt % | 3.4 | 3.5 |
| MFR of (A1) | g/10 min. | 160 | 185 |
| 2^{nd} Reactor - component (B1) | | | |
| Temperature | ° C. | 85 | 90 |
| Pressure | barg | 18 | 18 |
| H₂/C₂₋ | mol. | 0.30 | 0.80 |
| C₂₋7(C₂₋ + C₃₋) | mol. | 0.99 | 0.99 |
| Split | wt % | 38 | 36 |
| C₂₋ content of B1 * | wt % | 100 | 100 |
| C₄₋ content of B1 * | wt % | — | — |
| C₂₋ content of (A1 + B1) | wt % | 65.3 | 65.1 |
| C₄₋ content of (A1 + B1) | wt % | — | — |
| Xylene soluble of B1 (XS_{B1}) * | wt % | 1 | 1 |
| Xylene soluble of (A1 + B1) | wt % | 1.6 | 2.8 |
| MFR of B1 (MFR_{B1}) * | g/10 min | 0.45 | 27 |
| MFR of (A1 + B1) | g/10 min | 3.2 | 50 |
| 3^{rd} Reactor - component (C1) | | | |
| Temperature | ° C. | 60 | 60 |
| Pressure | barg | 16 | 16 |
| H₂/C₂₋ | mol. | 0.22 | 0.24 |
| C₂₋/(C₂₋ + C₃₋) | mol. | 0.5 | 0.47 |
| Split | wt % | 45 | 45 |
| C₂₋ content of C1 * | wt % | 65 | 63 |
| C₂₋ content of (A1 + B1 + C1) | wt % | 66.4 | 63.1 |
| Xylene soluble of (C1) (XS_{C1}) * | wt % | 72 | 74 |
| Properties of resulting Component | | | |
| AX | | | |
| MFR | g/10 min. | 0.74 | 3.0 |
| Density | gr/cc | 0.906 | 0.909 |
| Xylene soluble (XS_{TOT}) | wt % | 31.3 | 31.1 |
| Intrinsic Viscosity of XS_{TOT} | dl/g | 2.78 | 2.83 |
| C₂₋ content of XS_{TOT} | wt % | 57.8 | — |
| Total C₂₋ content | wt % | 66.9 | 63.5 |
| Flexural Modulus | MPa | 310 | 390 |

Notes:
C₂₋ = ethylene (IR); C₃₋ = propylene (IR); (IR); split = amount of polymer produced in the concerned reactor.
* Calculated values.

Polyolefin AY1 (LLD based) and Polyolefin AY2 (LLD based) were prepared as described in the Examples section of WIPO Appl. No. PCT/EP2016/064453, but with the differences reported in the following table regarding the composition of the single components:

TABLE AY

| | | Polyolefin | Polyolefin |
|---|---|---|---|
| Component AY | | AY1 | AY2 |
| 1^{st} Reactor - component (A2) | | | |
| Temperature | ° C. | 60 | 60 |
| Pressure | barg | 16 | 16 |
| H₂/H₃₋ | mol. | 0.19 | 018 |
| Split | wt % | 20 | 20 |
| Xylene soluble of (A2) (XS_{A2}) | wt % | 3.1 | 3.9 |
| MFR of (A2) | g/10 min. | 92 | 110 |
| 2^{nd} Reactor - component (B2) | | | |
| Temperature | ° C. | 80 | 80 |
| Pressure | barg | 18 | 18 |
| H₂/C₂₋ | mol. | 0.58 | 0.74 |
| C₄₋/(C₂₋ + C₄₋) | mol. | 0.19 | 0.17 |
| C₂₋/(C₂₋ + C₃₋) | mol. | 0.99 | 0.97 |
| Split | wt % | 33 | 38 |
| C₂₋ content of B2 * | wt % | 90 | 92 |
| C₄₋ content of B2 * | wt % | 10 | 8 |
| C₂₋ content of (A2 + B2) | wt % | 55.9 | 59.5 |
| C₄₋ content of (A2 + B2) | wt % | 5.8 | 5.2 |
| Xylene soluble of B2 (XS_{B2}) * | wt % | 16 | 8 |
| Xylene soluble of (A2 + B2) | wt % | 8.0 | 9.0 |
| MFR of B2 (MFR_{B2}) * | g/10 min | 3.7 | 11.0 |
| MFR of (A2 + B2) | g/10 min | 12.9 | 25 |
| 3^{rd} Reactor - component (C) | | | |
| Temperature | ° C. | 60 | 60 |
| Pressure | barg | 16 | 16 |
| H₂/C₂₋ | mol. | 0.25 | 0.29 |
| C₂₋/(C₂₋ + C₃₋) | mol. | 0.49 | 0.49 |
| Split | wt % | 47 | 42 |
| C₂₋ content of C2 * | wt % | 63 | 63 |
| C₂₋ content of (A2 + B2 + C2) | wt % | 59.6 | 60.2 |
| C₄₋ content of (A2 + B2 + C2) | wt % | 2.5 | 2.1 |
| Xylene soluble of (C2) (XS_{C2}) * | wt % | 74 | 74 |
| Properties of resulting Component | | | |
| AY | | | |
| MFR | g/10 min. | 0.85 | 2.4 |
| Density | gr/cc | 0.888 | 0.895 |
| Xylene soluble (XS_{TOT}) | wt % | 44.3 | 37.7 |
| Intrinsic Viscosity of XS_{TOT} | dl/g | 2.71 | 2.40 |
| Total C₂₋ content | wt % | 60.8 | 60.8 |
| Total C₄₋ content | wt % | 2.1 | — |
| Flexural Modulus | MPa | 190 | 220 |

Notes:
C₂₋ = ethylene (IR); C₃₋ = propylene (IR); C₄₋ = 1-butene (IR); split = amount of polymer produced in the concerned reactor.
* Calculated values.

### Component B

GF: Glass fibers: White ECS O3T 480 (Nippon Electric Glass Company Ltd), with a fiber length of 3 mm and a diameter of 13 μm, or

Glass fibers: Chopvantage™ HP 3270 (PPG Industries, Inc.) with a fiber length of 4.5 mm and a diameter of 10 μm.

### Component C

PP-MA: Propylene homopolymer grafted with maleic anhydride (MA), with an MFR of 430 g/10 min as measured according to ISO 1133, with a load of 2.16 kg at 230° C.; and an MA level (high) in the range of from 0.5 to 1.0 wt % (Exxelor™ PO 1020, sold by ExxonMobil Chemical Company).

### Component D

Metocene™ MF650Y is a commercial product sold by PolyMirae (MFR (230° C., 2.16 kg)) with an ASTM D 1238 L of 1,800 g/10 min and a density value with ASTM D 1505 of 0.91 g/cm³.

Metocene™ HM2015 is a commercial product sold by PolyMirae, a polypropylene homopolymer (MFR (230° C., 2.16 kg)) with an ASTM D 1238 L value of 140 g/10 min and a density value with ASTM D 1505 of 0.9 g/cm³).

CM688A is a commercial product sold by SunAllomer Ltd., a polypropylene copolymer having an MFR (with ISO 1873-2,2:95) of 9.9 g/10 min and a density value (with ISO 1873-2,2:95) 0.895 of g/cm³.

Moplen™ MP HF501N is a commercial product sold by LyondellBasell Industries, a polypropylene homopolymer with an MFR of 10 g/10 min (with ASTM D 1238) and a density value of 900 kg/m³ (with ISO 1183).

The compositions contain additives as indicated in Table 1.

The compositions were prepared by extrusion, using a twin screw extruder, model Werner&Pfleiderer ZSK40SC.

This line had a screw with a diameter (D) of 40 mm and a process length of approximately 48 L/D that was provided with gravimetric feeders. Components A, C and D were fed into the first barrel and component B was fed into the fourth barrel via forced side feeding.

A strand die plate with cooling bath and strand cutter (Scheer SGS100) was used to form pellets; vacuum degassing (barrel No. 9) was also applied to extract fumes and decomposition products.

Running Conditions:

Screw speed: 300 rpm;

Capacity: 40-50 kg/h;

Barrel Temperature: 200-240° C.

The final properties of the resulting composition are reported in Table 2, together with the relative amounts of the components.

The results reported in Table 2 show that the compositions of the present disclosure (Examples 1-6) exhibit a lower shrinkage at room temperature, without impairing in a substantial manner their mechanical properties, such as stiffness (measured by the Flexural Modulus method) and ductility (measured by the Impact Notched method) while presenting a higher MFR with respect to the Comparative Examples, which contain a different component A. This set of characteristics render the compositions of the present disclosure useful for the production of injection-molded articles, for example the interior parts of vehicles for the automotive industry.

TABLE 1

| | Comp. | Ex. | Ex. | Comp. | Comp. | Ex. | Ex. | Ex. | Ex. |
|---|---|---|---|---|---|---|---|---|---|
| Name (or Tradename) | Ex. 1 | 1 | 2 | Ex. 2 | Ex. 3 | 3 | 4 | 5 | 6 |
| Softell ™ CA 7469 A | 42 | — | — | 48 | 48 | — | — | — | — |
| HIFLEX ™ CA 7600 A | — | 44 | 48 | — | — | — | — | — | — |
| Polyolefin AX1 (HD based) | — | — | — | — | — | 41.6 | — | — | — |
| Polyolefin AX2 (HD based) | — | — | — | — | — | — | 41.6 | — | — |
| Polyolefin AY1 (LLD based) | — | — | — | — | — | — | — | 41.6 | — |
| Polyolefin AY2 (LLD based) | — | — | — | — | — | — | — | — | 41.6 |
| Metocene ™ MF650Y | 17 | — | 22 | 33 | 32 | 26 | 26 | 26 | 26 |
| Metocene ™ HM2015 | — | 26 | — | — | — | — | — | — | — |
| Glass Fibers ECS O3T 480 | 25 | — | — | 13 | — | — | — | — | — |
| Glass Fibers Chopvantage ® | — | 25 | 25 | — | 13 | 15 | 15 | 15 | 15 |
| 3270 | | | | | | | | | |
| Exxelor ™ PO 1020 | 1 | 1 | 1 | 1 | 1 | 1 | 1 | 1 | 1 |
| CM688A | — | — | — | — | — | 8 | 8 | 8 | 8 |
| Moplen ™ MP HF501N | 11 | — | — | — | — | — | — | — | — |
| Pigments, additives, flakes | 4 | 4 | 4 | 5 | 6 | 8.4 | 8.4 | 8.4 | 8.4 |
| | 100 | 100 | 100 | 100 | 100 | 100 | 100 | 100 | 100 |

TABLE 2

| | Acc. | | Comp. | | | Comp. | Comp. | | | | |
|---|---|---|---|---|---|---|---|---|---|---|---|
| Property | To | Unit | Ex. 1 | Ex. 1 | Ex. 2 | Ex. 2 | Ex. 3 | Ex. 3 | Ex. 4 | Ex. 5 | Ex. 6 |
| MFR (230° C., | ISO | g/10 | 2.7 | 12.6 | 22.7 | 11.5 | 8.9 | 19.5 | 38.8 | 23.1 | 33.6 |
| 2.16 kg) | 1133 | min | | | | | | | | | |
| Flexural | ISO | MPa | 3,605 | 3,204 | 3,165 | 2,132 | 2,214 | 2,716 | 2,822 | 2,419 | 2,499 |
| modulus | 178 | | | | | | | | | | |
| Impact notched | ISO | kJ/m² | 12.6 | 13.3 | 14.7 | 6 | 6.7 | 5.4 | 5.1 | 6.2 | 5.4 |
| at −30° C. | 179/1e | | | | | | | | | | |
| | A | | | | | | | | | | |
| Shrinkage | | | | | | | | | | | |
| 48 h/RT at 40 | | | | | | | | | | | |
| bar | | | | | | | | | | | |
| longitudinal | ISO | % | 0.18 | 0.12 | 0.09 | 0.32 | 0.26 | 0.19 | 0.22 | 0.16 | 0.18 |
| transversal | 2554 | % | 0.86 | 0.73 | 0.62 | 0.83 | 0.85 | 0.73 | 0.77 | 0.69 | 0.68 |

What is claimed is:

1. A composition having a melt flow rate (MFR), as measured according to ISO 1133 with a load of 2.16 kg at 230° C., of from 12 to 100 g/10 min, comprising:
A) 30-60% by weight of a polyolefin composition selected from AX and AY,
wherein AX comprises:
(A1) 5-35% by weight of a propylene-based polymer containing 90% by weight or more of propylene units and 10% by weight or less of a fraction soluble in xylene at 25° C. (XSA1), where both the amount of propylene units and the fraction XSA1 refer to the weight of (A1);
(B1) 25-50% by weight of an ethylene homopolymer containing 5% by weight or less of a fraction soluble in xylene at 25° C. (XSB1) referring to the weight of (B1); and
(C1) 30-60% by weight of a copolymer of ethylene and propylene containing from 25% to 75% by weight of ethylene units and 55% to 95% by weight of a fraction soluble in xylene at 25° C. (XSC1), where both the amount of ethylene units and the fraction XSC1 refers to the weight of (C1);
wherein the amounts of (A1), (B1) and (C1) being referred to the total weight of (A1)+(B1)+(C1); and
AY comprises:
(A2) 5-35% by weight of a propylene-based polymer containing 90% by weight or more of propylene units and 10% by weight or less of a fraction soluble in xylene at 25° C. (XSA2), where both the amount of propylene units and the fraction XSA2 refer to the weight of (A2);
(B2) 25-50% by weight of a copolymer of ethylene and a C₃-C₈ alpha-olefin containing from 0.1% to 20% by weight of alpha-olefin units and 75% by weight or less of a fraction soluble in xylene at 25° C. (XSB2), where both the amount of ethylene units and the fraction XSB2 refer to the weight of (B2); and
(C2) 30-60% by weight of a copolymer of ethylene and propylene containing from 25% to 75% by weight of ethylene units and 55% to 95% by weight of a fraction soluble in xylene at 25° C. (XSC2), where both the amount of ethylene units and of the fraction XSC2 refer to the weight of (C2);
wherein the amounts of (A2), (B2) and (C2) refer to the total weight of (A2)+(B2)+(C2);
B) 5-30% by weight of a glass fiber filler;
C) 0-5% by weight of a compatibilizer; and
D) 10-40% by weight of a polypropylene component selected from propylene homopolymers, propylene copolymers containing up to 5% by moles of ethylene or a C₄-C₁₀ α-olefin, and combinations thereof.

2. The composition according to claim 1, having an MFR from 12 to 50 g/10 min.

3. The composition according to claim 1, wherein component A is 40-55% by weight.

4. The composition according to claim 1, wherein component B is 10-25% by weight.

5. The composition according to claim 1, wherein component C is 0.5-3% by weight.

6. The composition according to claim 1, wherein component D is 15-35% by weight.

7. The composition according to claim 1, wherein the glass fibers of component B have a length of from 1 to 50 mm.

8. The composition according to claim 1, wherein the glass fibers of component B have a diameter of from 8 to 15 μm.

9. The composition according to claim 1, wherein component C has a Melt Flow Rate from 50 to 400 g/10 min.

10. The composition according to claim 1, wherein
the MFR of the polypropylene component D is of less than 500 g/10 min and component D comprises two polymer fractions D^{I} and D^{II} selected from the propylene homopolymers and copolymers, wherein fraction D^{II} has a higher MFR value with respect to D^{I}, with a difference of at least 3 g/10 min.

11. An injection molded article comprising:
the composition according to claim 1.

12. An extrusion article comprising:
the composition according to claim 1.

13. A thermoformed article comprising:
the composition according to claim 1.

14. A process for coloring a raw polymer comprising:
adding the composition according to claim 1 as a concentrate or a masterbatch to the raw polymer.

15. A process for preparing the composition according to claim 1, comprising the step of:
melting and mixing components A, B, C and D in a mixing apparatus at temperatures from 180 to 320° C.
